(19) United States
(12) Patent Application Publication
(10) Pub. No.: US 2015/0089576 A1
(43) Pub. Date: Mar. 26, 2015

(54) SYSTEMS AND METHODS FOR ADAPTIVE APPLICATION AND PRIVACY PRESERVING INTERNET OF THINGS

(71) Applicant: AMRITA VISHWA VIDYAPEETHAM, Coimbatore (IN)

(72) Inventors: Jayaraj POROOR, Kodungallur (IN); Shiju SATHYADEVAN, Kollam (IN)

(21) Appl. No.: 14/488,816

(22) Filed: Sep. 17, 2014

(30) Foreign Application Priority Data
Sep. 17, 2013 (IN) 4166/CHE/2013

(51) Int. Cl. G06F 21/62; H04L 29/06

(52) U.S. Cl. CPC G06F 21/6218; H04L 63/04
USPC 726/1

(57) ABSTRACT

The present invention provides system and method for adaptive application and privacy preserving internet of things. The system comprises of at least one configured IoT device(s) (A) for receiving, processing, filtering, storing and transferring limited information to at least one receiving IoT device(s) (R1, R2, . . . , Rn), at least one inputting IoT device(s) (ID1, ID2, . . . IDn) for transferring information to said IoT device(s) (A), at least one memory unit (M) for storing processed information in said configured IoT device (A), at least one communication interface (C) for communication between IoT device(s), at least one receiving IoT device(s) (R1, R2, . . . Rn) to receive processed information from said configured IoT device (A) as per the information flow policies (P) thereby limiting the type and amount of private information that can be supplied or leaked to the public from one IoT device irrespective of the application running on the IoT device.

### FIELD OF THE INVENTION

The present invention relates to systems and methods for adaptive application and privacy preserving internet of things (IoT). More specifically the present invention discloses system and method for configuring the internet of things (IoT) devices such that their functionality is adapted according to a given information flow policy of applications while simultaneously preserving the privacy of the shared information.

### BACKGROUND OF THE INVENTION

The internet technology has evolved with changing needs of industry and society. It is now possible for almost every device to connect to the internet enabling its access from anywhere around the globe at anytime. For instance, a smart phone, tablet, printer, TV or even good old PCs can be connected and controlled on the internet, thereby creating an internet of things.

The term ‘Internet of Things’ was first coined in 2009 by Kevin Ashton a British pioneer who cofounded the Auto-ID centre at Massachusetts Institute of Technology, United States of America. The term basically means connecting physical objects virtually to the internet.

Internet of Things (IoT) is a promising technology development that aims to seamlessly connect embedded sensors and tags to the Internet in order to capture, integrate, and process their information using servers and computing clouds located anywhere across the globe. IoT enables receiving, storing and processing of data from various devices connected to the internet and obtain useful information from them, which can be used to respond accordingly. IoT has been used in CCTV surveillance, remote monitoring of patients and aged, smart homes, etc.

The data from many IoT devices may be part of private spaces. Therefore, it is of foremost importance that due care is observed in order to protect the privacy of the inhabitants and processing the data before it may be sent to the outside world. Therefore, rather than the IoT device merely acting as an input/output device and the receiver or the cloud carrying the processing of information, there is a need for a system to configure the IoT device of the sender to simultaneously cater to different IoT applications and preserve privacy of information exchanged between the IoT devices. In order to ensure privacy irrespective of the application running on the IoT device, a system is required to specify and enforce the privacy policy of the device independent of the application logic.

For instance, in case of an Internet-connected (IoT) camera which is used for monitoring the sleep pattern of elderly people, the action of transmitting the captured images to doctors or close relatives, or any other person outside the room would tantamount to sending the images to the outside world. The viewing of such images by an unauthorized person is liable to be considered a serious breach of privacy by the inhabitant. To overcome this privacy issue, one should be able to process the images within the camera itself and only supply the sleep pattern information to the doctor or close relatives. To guarantee privacy, a manufacturer may conventionally choose to hardwire the processing logic within the camera. The formal information flow model that is used to specify and enforce such a limit on information is a classical lattice model of information flow, which can specify only one of the two situations i.e. either the information can flow or it cannot flow. Thus the hardwiring of the processing logic within the camera will help in preserving private information but such hardwiring at the same time, will make the camera fit for only that one single purpose i.e. monitoring the sleep pattern of elderly people.

The IoT devices such as an internet connected camera are capable of running on more than one application. For instance, the internet connected camera apart from monitoring sleep patterns of patients can also be used to detect fall events in an elderly care setting or used for face detection in a security setting. Therefore there is a need for a system to preserve the privacy of information flowing through an IoT device but also at the same time enable the IoT device to be able to adapt its functionality according to the application.

IoT envisages saturating our world with physical objects embedded with sensors and miniscule computing devices. Such systems continuously generate event data from embedded sensors, for example, producing real-time data streams. In order to take advantage of the current scenario, these events need to be concurrently processed by applications running in computing systems ranging from embedded to server systems. Due to lack of fundamental research and development in proper programming abstractions for such systems the same is not achieved yet. Therefore, there is a need for a system which provides good programming abstractions to easily take advantage of true concurrency offered by multi-cores for concurrent data processing.

With advances in scientific research, today the technology is constantly being upgraded and every new device or object has the capability to do several tasks or functions which can be exercised whenever the need arises. In such a scenario limiting the functions to a single purpose would render the technology useless. Therefore, in order to keep up with such changes and to be able to be at par with it, a need arises for an application-independent system and method that not only preserves the privacy of the huge information flowing between devices but also ensures the ability of the device to adapt its functionality according to the needs of the application.

### OBJECT OF THE INVENTION

In order to obviate the drawbacks in the existing state of the art technology the main object of the present invention is to provide a system and method to limit the type and amount of private information that can be supplied or leaked to the public from the arena of the internet of things (IoT).

Yet another object of the present invention is to configure an IoT device to simultaneously cater to different IoT applications and preserve privacy of information exchanged between the IoT devices.

Yet another object of the present invention is to provide for a system and method to specify and enforce the privacy policy of the IoT device irrespective of the application running on the IoT device.

Another object of the present invention is to provide systems and methods to empower IoT devices to adapt to their functionality according to the needs of the application.

A further object of the present invention is to provide systems and methods capable of downloading and executing the required application components known as IoT Applets—or IoTAs, on-demand by the IoT devices.

Yet another object of the present invention is to provide for a system which provides good programming abstractions to easily take advantage of true concurrency offered by multi-cores for concurrent data processing.

### SUMMARY OF THE INVENTION

Accordingly, the present invention provides for system and method for configuring the internet of things (IoT) according to a given information flow policy of applications while simultaneously preserving the privacy of the shared information. The present invention limits the type and amount of private information that can be supplied or leaked to the public from one IoT device irrespective of the application running of the IoT device. The present invention employs the concept of information-limit channels thereby restricting the information that can be carried through the channels between IoT devices.

The IoT device is so configured so as perform different tasks simultaneously. For e.g. an Internet-connected camera can be used to download the required IoT Applets (IoTAs) relating a set of actions such as monitoring the sleep patterns of elderly people or detecting fall events in an elderly care setting or for some other function, while simultaneously executing these functions. By keeping the application logic not fixed, the present invention can adapt the IoT device for diverse purposes.

Further to ensure privacy of the shared information irrespective of which application components (IoTA) is currently being executed, the present invention provides a system and method to specify and enforce the privacy policy of the IoT device thereby providing a general solution to the privacy issue problem of such adaptive IoT devices.

The present invention provides a system and method allows the development of components relating to each application or event known as event-driven concurrent components that can act has IoTAs for IoT devices where the event-driven concurrent components are called handlers. Handlers communicate with each other and with the outside world via typed channels, allowing information flow policies to be specified and enforced at language-level. This can be used to limit the type and amount of private information that can be supplied or leaked to the public world.

The present invention is capable of specifying and enforcing privacy policies using limited information flow channels thereby preserving privacy up to an information flow limit that is enforced by the system. To limit the information flow present system comprises of three components namely; event parameter types and bandwidth limit which control the type and amount of information that can flow from one channel to the other; de-synchronization time window which regulates the time in which the information flows from one channel to the other channel.

Unlike the classical lattice model of information flow, which can specify only two situations i.e. either there is a flow of information or there is no flow of information; the system in the present invention comprises of yet another parameter, i.e. the situation where there is flow of information with pre-determined limitation(s).

For instance, the present invention may specify that the images captured from an internet connected camera shall flow from the camera to the doctor provided the three parameters i.e. event parameter types, bandwidth-limit and de-synchronization time window relating to the channel where the doctor receives the images are set to fixed levels. In order to specify such flow of information policies, the present invention provides for information flow graph. The nodes in the information flow graph represent information flow labels. Some of the information flow labels carry constraints that indicate the number of times the information can be sent across the flow channels. If the constraint is “one” then the information from the camera can be sent to the doctor over the flow channel only once.

Thus the present invention safeguards the preservation of privacy by internet of things devices and provides systems and methods for adaptive privacy-preserving internet of things.

### BRIEF DESCRIPTION OF DRAWINGS

FIG. 1 shows a system flowchart of one embodiment of the adaptive privacy preserving system.

FIG. 2 shows a system flowchart of another embodiment of the adaptive privacy preserving system.

FIG. 3 shows a method flowchart for the working of the invention.

FIG. 4 shows a method of regulating flow of information according to information flow policy of the present invention.

FIG. 5 shows a schematic view of the runtime architecture of the system.

### DETAILED DESCRIPTION OF THE INVENTION

The present invention provides for systems and methods for adaptive application and privacy preserving internet of things (IoT). The system of the present invention receives information, processes it, filters or limits the type and amount of private information that can be supplied or leaked to the public from one IoT device irrespective of the application running of the IoT device. The present invention employs the concept of information-limit channels meaning that the information that can be carried through the channels between IoT devices is restrictive.

The term ‘handler(s) (H1, H2, . . . , Hn)’ used in the complete specification shall mean event driven components that communicate with each other and with the outside world via typed channels, allowing information flow policies to be specified and enforced.

The term ‘Channel (CH1, CH2, CH3, . . . CHn)’ used in this complete specification shall mean a medium through which information between IoT devices flows. A channel maybe static or dynamic and external or internal.

The term ‘information flow policy (P)’ used in this specification shall mean a limiting policy preserving the privacy of information based on event parameters (E1, E2, . . . , En), bandwidth limits (L1, L2, . . . , Ln) and de-synchronization time window (T1, T2, . . . , Tn).

The term ‘data acquisition channel (CH1)’ used in this complete specification shall mean the external channel of the configured IoT device (A) that receives all the information as it is form various IoT devices (ID1, ID2, . . . , IDn).

The term ‘data summary channel (CH2)’ used in this complete specification shall mean the internal channel of the configured IoT device (A) which processes and filters the information received from data acquisition channel (CH2) depending on information policy flow (P).

The term ‘information service channel (CH3)’ used in this complete specification means the external channel of the configured IoT device (A) which sends limited information to the outside world and receiving IoT devices (R1, R2, . . . Rn) thereby preserving privacy.

The system of the present invention comprises of IoT devices (ID1, ID2, IDn) from which the information is inputed to a configured IoT device(s) (A), a memory unit (M) for storing the information processed in the configured IoT device (A), a communication interface (C) for the configured IoT device(s) (A) to communicate with the receiving IoT device(s) (R1, R2, . . . , Rn) as per the information flow policy (P). For example, in case of an internet connected (IoT) camera which is used to capture images of an elderly patient's sleep patterns to be sent only to the doctor provided that the information flow policy (P) satisfies the three parameters of the programming language, i.e. event parameter types (E1, E2, . . . , E3), bandwidth-limit (L1, L2, . . . , Ln) and de-synchronization time window (T1, T2, . . . Tn) relating to the channel where the doctor receives the images are set to fixed levels. Here, the camera is the configured IoT device (A), the memory unit (M) for storing the images which maybe present in the IoT camera or maybe stored in the cloud, and the receiving IoT device(s) (R1,R2, . . . Rn) is of the doctor which may receive the information from any communication interface (C).

The method of working of the system of the present invention comprises the steps of:
(1) Inputting information from various IoT devices (R1, R2, Rn) to the configured IoT device (A),
(2) Receiving all the information at the data acquisition channel (CH1) of the configured IoT device (A),
(3) Transferring received information to data summary channel (CH2) of the configured IoT device (A),
(4) Processing and filtering the received information based on the information flow policy (P) of event parameters (E1,E2, . . . , En), bandwidth limits (L1, L2, . . . Ln), de-synchronization time window (T1, T2, . . . Tn),
(5) Transferring filtered information to the information service channel (CH3)
(6) Storing filtered information in a memory unit (M),
(7) transferring only the filtered information to the receiving IoT device(s) (R1,R2, . . . Rn) as per the information flow policy (P) of the application and limiting rest of the information irrespective of the application, thereby ensuring preservation of privacy.

The present invention also configures an IoT device (A), such as an Internet-connected camera used to download the required IoTAs relating for example to monitoring the sleep patterns of elderly people or detecting fall events in an elderly care setting or for some other function while simultaneously be used to execute the said functions. By keeping the application logic not fixed, the present invention can adapt the IoT device (A) for diverse purposes.

Further to ensure privacy of the shared information irrespective of which application components (IoTAs) are currently being executed, the present invention provides for systems and methods to specify and enforce the information flow policy (P) of the IoT device (A) thereby providing a general solution to the privacy issue problem of such adaptive IoT devices (A). The system is capable of configuring an IoT device (A) to take advantage of multi-cores wherever available for rapid event processing.

The present invention is capable of specifying and enforcing information flow policies (P) using limited information flow channels thereby preserving privacy up to an information flow limit that is enforced by the system. To control the type, quantity and time at which the information shall flow from an internal channel to the outside world, the information flow policy (P) utilizes three components namely; event parameter types (E1,E2, . . . En) and bandwidth limit (L1, L2, . . . Ln) which control the type and amount of information that can flow from one channel to the other and de-synchronization time window (T1, T2, . . . Tn) which regulates the time in which the information flows from one channel to the other channel. The information flow policy (P) can be defined within the IoT device (A) dynamically using the IoTA approach giving it a lot of flexibility in allowing different IoT specific applets to run within the IoT device (A).

Unlike the classical lattice model of information flow, which can specify only two situations i.e. either there is a flow of information or there is no flow of information; the limited information flow channels introduces yet another parameter, i.e. the situation where there is flow of information with pre-determined limitation(s).

The system allows development of components relating to each application or event known as event-driven concurrent components called handlers (H1,H2, . . . Hn) that can act has IoTAs for IoT devices (A). Handlers (H1,H2, . . . Hn) communicate with each other and with the outside world via typed channels (CH1,CH2,CH3, . . . CHn), allowing information flow policies (P) to be specified and enforced at language-level. This can be used to limit the type and amount of private information that can be supplied or leaked to the public world. A channel (CH1,CH2,CH3, . . . CHn) defines a set of events, including the event name and event parameters that the event would take depending upon the policy of information flow.

A channel (CH1,CH2,CH3, . . . CHn) is a medium through which information flows. Each channel (CH1,CH2,CH3, . . . CHn) has a type, which is defined by ‘channel type’. Each channel type provides a set of events. Events can be external or internal.

Channels (CH1,CH2,CH3, . . . CHn) can be static or dynamic. Static channels are those that are declaratively specified in the program and which are automatically created at runtime while dynamic channels are those which are explicitly created at runtime depending upon the policy of information flow. Handlers (H1,H2, . . . Hn) adapt to specific channels (CH1,CH2,CH3, . . . CHn) and handle the events defined by specific channels (CH1,CH2,CH3, . . . CHn).

Channels (CH1,CH2,CH3, . . . CHn) are further classified into internal channel and external channel. External channels are similar to sensors which retrieve data from the outside world and other IoT devices. Internal channels are for data handling. Each channel (CH1,CH2,CH3, . . . CHn) has a handler (H1,H2, . . . Hn) of its own. Handlers (H1,H2, . . . Hn) communicate with each other and with the outside world via channels (CH1,CH2,CH3, . . . CHn).

The event of each channel (CH1,CH2,CH3, . . . CHn) is stored to a queue called pending event queue. Corresponding parameters of each event is stored as a list. Each event may be triggered and mapped to active channel queue and from this the next event will be invoked or called. Runtime may not allow multiple running of same event at a time thereby regulating the information flow. When queue is full either the channel must block (e.g., when specifying in-memory queues) or the operation simply returns with no effect (lossy, distributed channel) or it simply pushes the oldest entry out (real-time data streams). A receive operation on an empty channel either returns a default value (polling mode) or blocks. The channels may be configured for any of these scenarios.

For instance, the present invention may specify that the images captured from an internet connected camera shall flow from the camera to the doctor provided the three parameters, i.e. event parameter types (E1,E2, . . . En), bandwidth-limit (L1, L2, . . . Ln) and de-synchronization time window (T1,T2, . . . Tn) relating to the channel where the doctor receives the images are set to fixed levels. In order to specify such flow of information policies, the present invention provides for information flow graph. The nodes in the information flow graph represent information flow labels. Some of the information flow labels carry constraints that indicate the number of times the information can be sent across the flow channels. If the constraint is “one” then the information from the camera can be sent to the doctor over the flow channel only once.

These constraints can be programmed to regulate and limit the flow of information where for example the limit can be denoted as “1”, the camera as “f1” and doctor as “f2”. Using this terminology, if a flow label denoted as “f1 to f2 up to limit l, where l=1 per day”, is processed then the information can flow only once per day from channel f1 to f2. This ensures that the images captured by the internet connected camera are received only once per day by the doctor and nobody else. Thereby enforcing the information policy, that data over a certain limit will not be allowed to flow out of the internal channel to an external device.

For instance, in case of monitoring of elderly people in an old age nursing home using cameras. Cameras are used in their private living space and hence it is important to limit the information that flows from such devices to external world. Image processing techniques can be employed to identify events of interest (fall event, sleeping abnormality event etc). The information flow policy creates a channel called “Fall Detection Channel”. Once the fall event is detected the relevant information only processed and transferred over the “Fall Detection Channel” to authorized recipients like doctors, nurses, caretakers, etc to access such information. The volume of information that may flow through the “Fall Detection Channel” can be limited to at any one instance. This will enforce that data over a certain limit will not be allowed to flow out of the internal channel to external device. This ensures that privacy is preserved at all times.

In another instance, in a cluster of networked medical sensors (e.g. thermometers), when a device is faulty it will need to communicate with the support center. In such cases a channel of a specific type (encrypted channel) can be defined. The number of such transmissions per period of time and the volume of data that can flow through the channel can then be pre-defined and restricted. This will then limit the type of data (device ID and few other device health parameters), frequency of flow and volume of data that can flow through the channel.

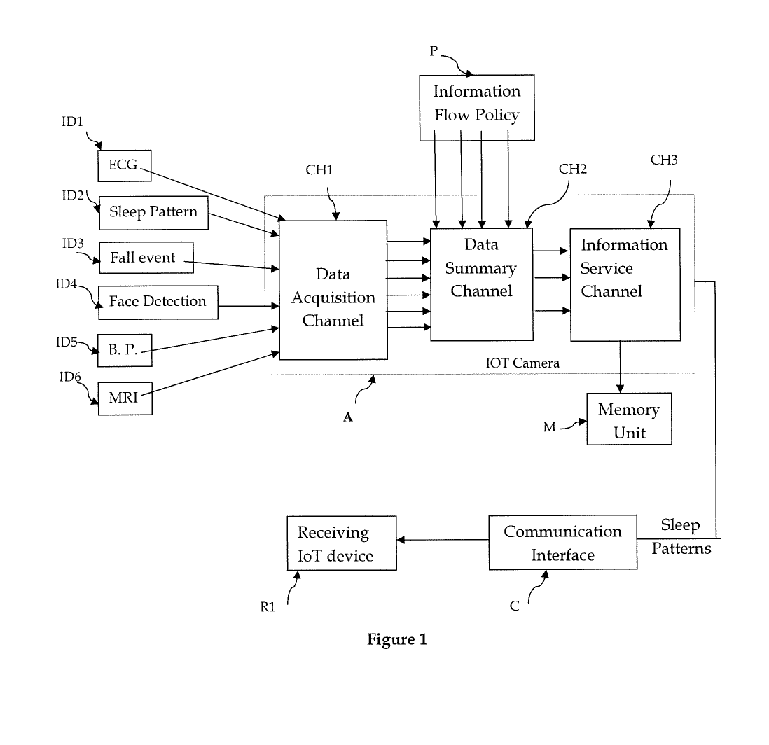

In one embodiment of the system of the present invention, FIG. 1 depicts an Internet connected (IoT) Camera (A) configured for monitoring the sleep pattern of patients but receives a plethora of information relating to fall events, face detection, ECG, BP, MRI, etc., from inputting IoT devices (ID1, ID2, ID3, ID4, ID5, ID6). The configured IoT camera (A) comprises of at least one data acquisition channel (CH1), at least one a data summary channel (CH2) and at least one information service channel (CH3) for specifying and enforcing information flow policy (P). The Information from the inputting IoT devices (ID1, ID6) is received at the data acquisition channel (CH1) which further transfers the received information to the data summary channel (CH2) where the received information is processed and filtered based on the information flow policy (P). The processed and filtered information is then further transferred to the information service channel (CH3). At the information service channel (CH3) based on the information flow policy (P) some information is withheld and stored in the memory unit (M) while some is allowed to flow, for example the information related to sleep patterns of the patient is allowed to flow to the receiving IoT device (R1) via the communication interface (C).

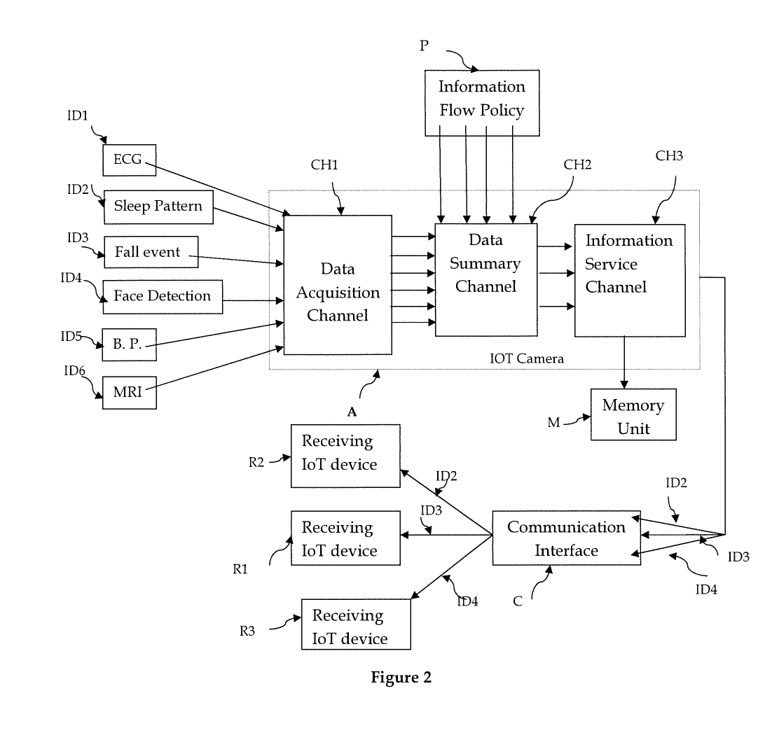

In another embodiment of the system of the present invention, FIG. 2 depicts an Internet connected (IoT) Camera (A) configured for monitoring the sleep pattern of patients, for detecting fall events in elderly people, for face detection in security setting and for transferring other information received from inputting IoT devices (ID1, ID2, ID3, ID4, ID5, ID6) such as ECG, BP, MRI, etc. The configured IoT camera (A) comprises of at least one data acquisition channel (CH1), at least one a data summary channel (CH2) and at least one information service channel (CH3) for specifying and enforcing information flow policy (P). The Information from the inputting IoT devices (ID1, . . . , ID6) is received at the data acquisition channel (CH1) which further transfers the received information to the data summary channel (CH2) where the received information is processed, categorized and filtered based on the information flow policy (P). The processed and filtered information is then further transferred to the information service channel (CH3). At the information service channel (CH3) based on the information flow policy (P) some information is withheld and stored in the memory unit (M) while some is allowed to flow, for example the information related to sleep patterns of the patient is allowed to flow to the receiving IoT device (R1), the information relating to fall event of elderly to receiving IoT device (R2) and the information relating to face detection to IoT device (R3) via the communication interface (C).

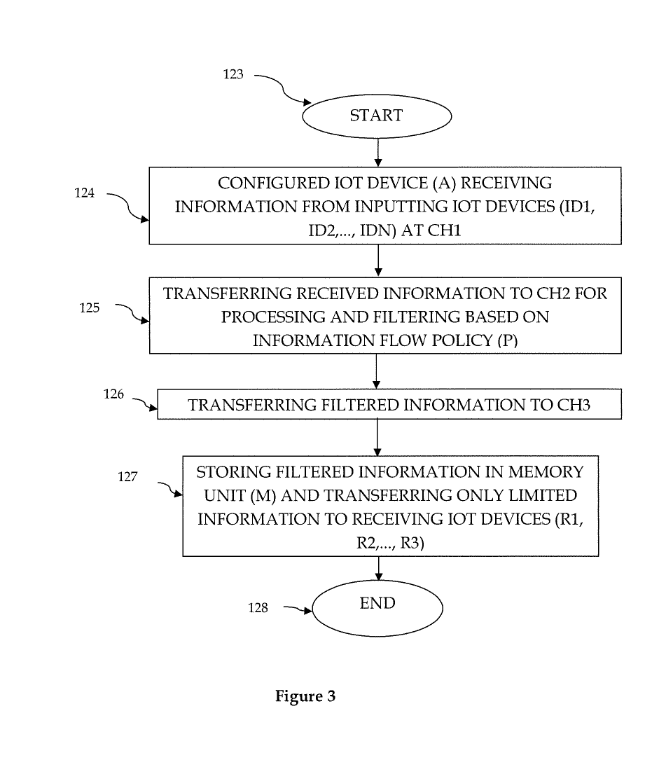

FIG. 3 shows a method flowchart for the working of the system of the present invention. The method for working of the system for preservation of private information flowing among internet of things (IoT) comprises the steps of:
(i) the configured IoT device (A) receiving information from inputting IoT devices (ID1, ID2, . . . , IDn) at the data acquisition channel (CH1) (124)
(ii) transferring received information to the data summary channel (CH2) for processing and filtering of the received information based on information flow policy (P) (125)
(iii) transferring the processed and filtered information to the information service channel (CH3) (126)
(iv) storing filtered information in memory unit (M) and transferring only limited information to receiving IoT devices (R1, R2, . . . , Rn) (127)

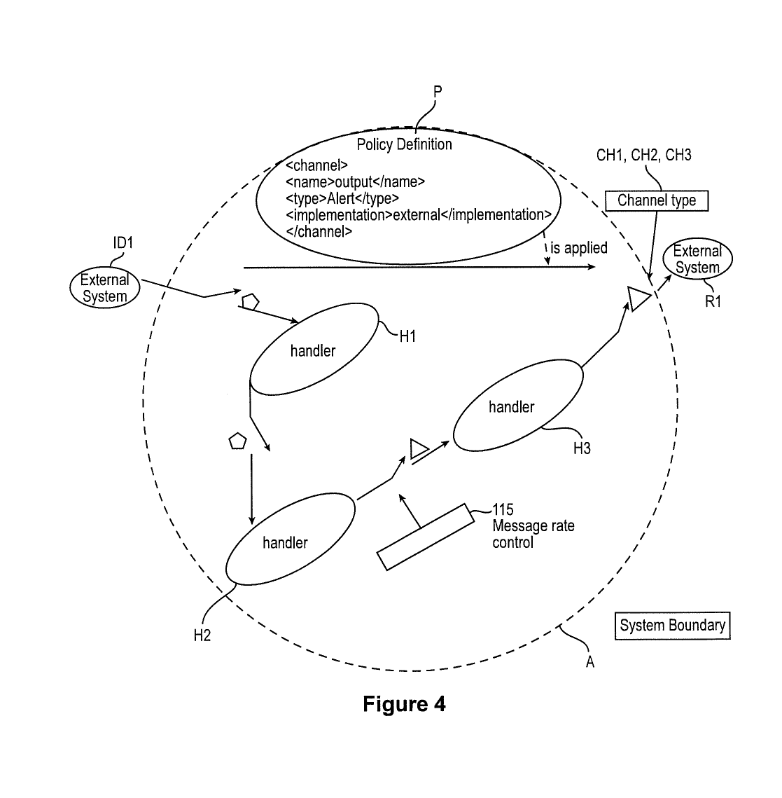

FIG. 4 shows a method of regulating flow of information according to information flow policy of the present invention. The figure shows channels (CH1, CH2 and CH3) through which the information flows between the external system of the inputting IoT device (ID1), the configured IoT device (A) and the external system of the receiving IoT device (R1) based on the information flow policy (P). Each channel has a type defined by channeltype which provides a set of events, for example if the channeltype then it may be programmed to provide the event of notify such that when an alert channeltype is detected the channel is notified. The Handlers (H1, H2 and H3) invoke the events associated with channels. The information flow policy (P) limits the information from one channel to the other. Message rate control (115) is used to control the rate of flow of information through the channels (CH1, CH2, CH3).

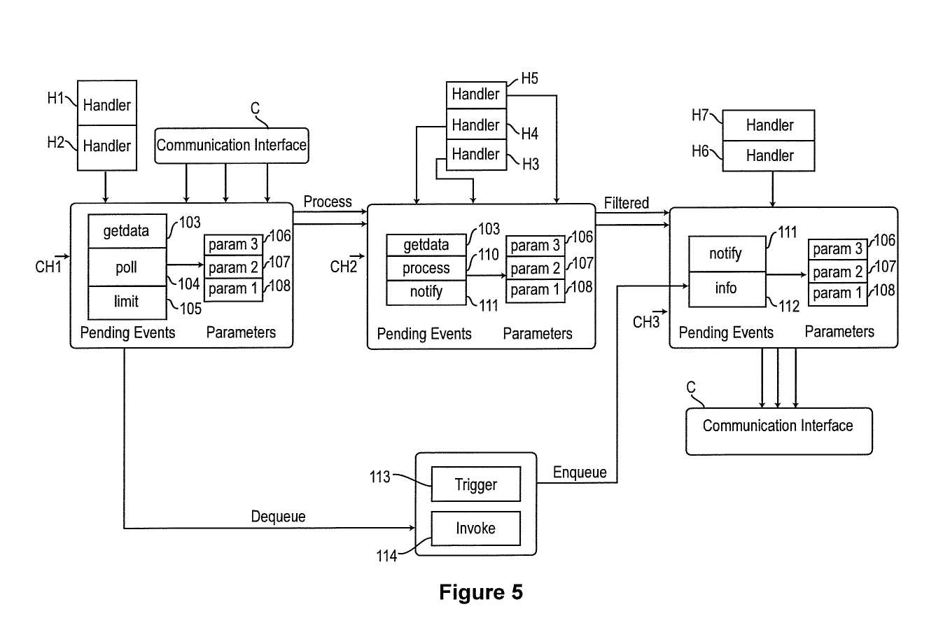

FIG. 5 shows a schematic view of the architecture of the system. In the system of the present invention there are internal channels (CH2) and external channels (CH1, CH3). External channels (CH2, CH3) are capable of retrieving data from outside world like sensors or other inputting devices while internal channels (CH2) are capable of handling the information. A channel is identifies by type, name, implementation and URL. Each Channel has a handlers of its own which communicates with are capable of communicating with each other and with the outside world via channels. Handlers listen to specific channels and invoke events defined by those channels. As shown handlers (H1, H2) listen to channel (CH1) where all the information through the communication interface (C) is received and kept in pending queue (103,104,105) depending upon the parameters (106,107,108). The Handlers (H1,H2) invoke (114) the event when required. The information from channel (CH1) is transferred to channel (CH2) for processing and filtering via handlers (H3,H4,H5). The filtered information then is received by channel (CH3) via handlers (H6,H7) and depending on the event parameters (111, 112) in queue when triggered (113), the information is notified (111) to receiving device via communication interface (C) thereby limiting the amount and type of flow of information.

Thus the present invention safeguards the preservation of privacy by internet of things devices and provides systems and methods for adaptive privacy-preserving internet of things.

1. A novel system for adaptive application and privacy preserving internet of things (IoT) for configured processing and preservation of private information flowing among internet of things (IoT) devices, said system comprising of
(i) at least one configured IoT device(s) comprising of multiple channels for receiving information, processing, filtering and storing and transferring limited information to at least one receiving IoT device(s), said IoT device being configured to information flow policy,
(ii) at least one inputting IoT device(s) for transferring information to said IoT device(s) configured to at least one information flow policy,
(iii) at least one memory unit for storing processed information in said configured IoT device,
(iv) at least one communication interface for communication between IoT device(s),
(v) at least one receiving IoT device(s) to receive processed information from said configured IoT device as per the information flow policies
such that inputted information is filtered on the basis of the configured information flow policy of the adaptive application to provide processed information which is stored in secure environment, said stored processed information capable of being transferred on demand through secure communication thereby preserving privacy.

2. The novel system for adaptive application and privacy preserving internet of things (IoT) as claimed in claim 1, wherein said configured IoT device(s) comprises of:
(i) at least one data acquisition channel for receiving information from said inputting IoT device(s),
(ii) at least one data summary channel for processing and categorizing (or filtering) said received information based on said information flow policy,
(iii) at least one information service channel for transferring said categorized (or filtered) information to said receiving IoT device(s),
(iv) at least one event driven concurrent component(s) called handler controlled by said channels.

3. The novel system for adaptive application and privacy preserving internet of things (IoT) as claimed in claim 1, wherein said configured IoT device(s) is capable of adapting its functionality according to at least one information flow policy while simultaneously preserving the privacy of said information.

4. The novel system for adaptive application and privacy preserving internet of things (IoT) as claimed in claim 1, wherein said system specifies and enforces said information flow policy on said configured IoT device(s) comprising components selected from,
(i) at least one event parameter capable of controlling the type of information that may flow through said channels,
(ii) at least one bandwidth limit capable of controlling the amount of information that may flow through said channels,
(iii) at least one de-synchronization time window capable of regulating the time in which the information may flow through said channels.

5. A method of operating the system for adaptive application and privacy preserving internet of things (IoT) as claimed in claim 1, wherein said method comprises the steps of,
inputting information from said inputting IoT device(s) to said configured IoT device(s),
receiving said information at the data acquisition channel of said configured IoT device(s),
transferring said received information to data summary channel of said configured IoT device(s),
subjecting said received information to information flow policy for processing and filtering said information to obtain processed information,
transferring said processed information to the information service channel for storage,
storing said processed information in said memory unit in secure environment,
transferring said processed information in a secure manner to said receiving IoT device(s) based on said information flow policy,
such that private information inputted in said configured IoT device(s) is preserved irrespective of the application running on said configured IoT device(s).
